(19) United States
(12) Patent Application Publication
(10) Pub. No.: US 2025/0330411 A1
(43) Pub. Date: Oct. 23, 2025

(54) NETWORK PACKET PROCESSING FLOW TESTS

(71) Applicant: MELLANOX TECHNOLOGIES, LTD., Yokneam (IL)

(72) Inventors: Elya Gurvitz, Center District (IL); Yohad Dickman, Karmiel (IL); Gal Shalom, Givat-Avni (IL); Aviad Yehezkel, Yokneam Ilit (IL); Omri Kahalon, Tel Aviv (IL)

(21) Appl. No.: 18/638,254

(22) Filed: Apr. 17, 2024

(51) Int. Cl. H04L 43/50; H04L 43/062

(52) U.S. Cl. CPC H04L 43/50; H04L 43/062

(57) ABSTRACT

Systems and methods herein are for at least one circuit that can be associated with a host controller and that can enable a network element to perform a test of packet processing flow in a network, where instructions can be performed for different match-action tables in an order so that first instructions of the different match-action tables can generate test packets for the packet processing flow, second instructions can provide rules associated with the packet processing flow, and third instructions can perform verification of the test based on the rules under the test and using the test packets.

### TECHNICAL FIELD

At least one embodiment pertains to testing of packet processing flow in a data network.

### BACKGROUND

Data processing unit (DPUs) and network interface cards (NICs), collectively referenced herein as network elements, may include hardware and software capabilities for implementing a programmable packet processing flow. The packet processing flow allows for, among other capabilities, modification of packets, duplication of packets, filtering of packets, and routing of packets, as pertaining to ports of a network element. The packet processing flow may be programmable and may be a complex endeavor. Further, the packet processing flow may be tested thoroughly to ascertain that the packet processing flow is functioning as intended. Such tests may be typically carried out by inserting test packets into the packet processing flow and by observing an output packet. For example, contents and at least a destination of the output packet may be observed. The testing process may be driven by a host controller and may be slow or subject to latency at least because of a required interaction with the host controller. The slowness or latency in the tests may result in partial testing of the packet processing flow.

### BRIEF DESCRIPTION OF DRAWINGS

FIG. 1 illustrates a system that is subject to testing of a packet processing flow performed in hardware associated with at least one network element, according to at least one embodiment;

FIG. 2 illustrates aspects of a system for testing of a packet processing flow performed in hardware associated with at least one network element, according to at least one embodiment;

FIG. 3 illustrates further aspects of a system for testing of a packet processing flow performed in hardware associated with at least one network element, according to at least one embodiment;

FIG. 4 illustrates computer aspects for testing of a packet processing flow performed in hardware associated with at least one network element, according to at least one embodiment;

FIG. 5 illustrates a process flow for a system for testing of a packet processing flow performed in hardware associated with at least one network element, according to at least one embodiment;

FIG. 6 illustrates a further process flow for a system for testing of a packet processing flow performed in hardware associated with at least one network element, according to at least one embodiment; and

FIG. 7 illustrates yet another process flow for a system for testing of a packet processing flow performed in hardware associated with at least one network element, according to at least one embodiment.

### DETAILED DESCRIPTION

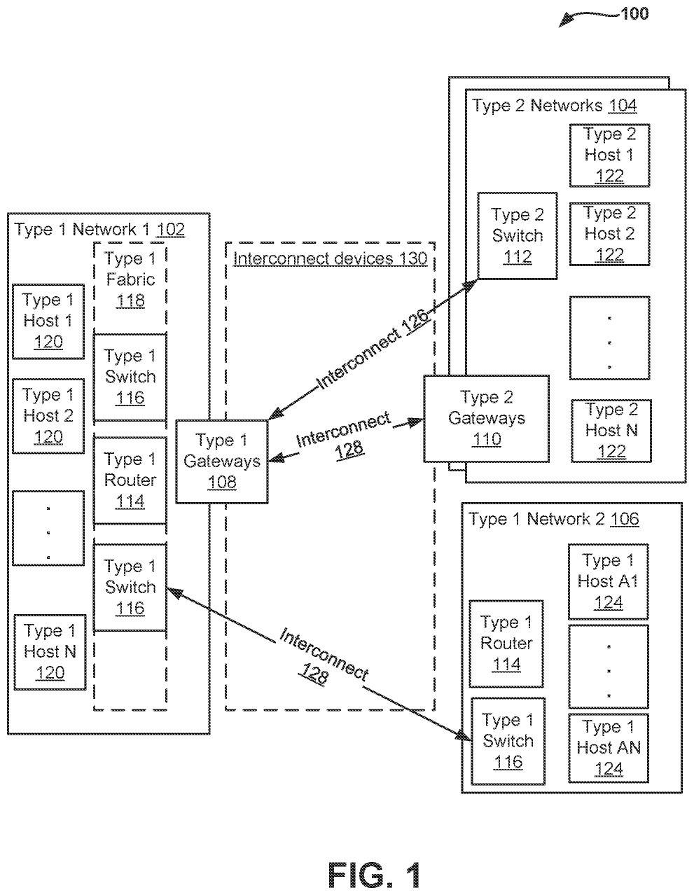

In at least one embodiment, FIG. 1 illustrates a system 100 that is subject to testing of a packet processing flow performed in hardware associated with at least one network element, as detailed herein. The system 100 provides hardware to perform a test of a packet processing flow in a network element, such as switch, a network interface card (NIC), a router, network filters, and other such devices. Therefore, one or more of the illustrated devices, such as the interconnect devices may be network elements, as used herein. In one example, match-action tables may be provided with instructions that may be conditional actions and that may be fully offloaded to a hardware of a corresponding network element. The hardware performs a test using the instructions and performs verification of the test. The test represents the full test loop and the hardware returns results after the verification is completed without software of a network controller being involved in performing the full test loop.

While the test and verification of the test herein are performed in the hardware, source code or configuration for all aspects of the test may be arranged in a host controller and may be compiled or formatted to provide packet match rules in the host controller. The packet match rules can represent the different match-action tables and includes the instructions. Further, the packet match rules may be offloaded to a network element to perform the test of at least one packet processing flow. For example, the test may be performed according to the match-action tables so that instructions that may include the conditional actions are satisfied in each match-action table to allow control to be transferred to a subsequent match-action table or to allow control to loop back to the first match-action table so that the test covers all the network references (such as addresses) of the network.

Therefore, in one example, a system to perform a test of a packet processing flow includes a host controller to allow arrangement of the source code or configuration suitable to the test and a network element to perform the test using the packet match rules from compiled source code or formatted configuration. The host controller and the network element may include at least one circuit having at least one execution unit of a processor. The network element can perform the test of the packet processing flow using its execution unit to perform the instructions of the different match-action tables.

In at least one embodiment, the match-action tables allows for control to transfer in a cyclic action. For example, a first one of the match-action tables may receive one or more initial or template test packet(s) from a host controller. This one or more initial or template test packet(s) may be part of a trigger or may trigger the test to start. The first one of the match-action tables includes first instructions for generation of test packets to the packet match rules under the test. A second one of the match-action tables can take control and includes second instructions to provide the packet match-action rules under test. The third one of the match-action tables can take control and includes instructions to perform verification of the test performed. The verification may include, in one example, counting a number of test packets that match one of the match-action rules in the third one of the match-action tables. The match may be as to a packet format. The third one of the match-action tables can perform the cyclic action by looping back control to the first one of the match-action tables for generating the next test packet, or can return indication of success or failure to the host controller.

In at least one embodiment, the system 100 includes one or more type 1 networks 1 102, 2 106 that may be peer to peer high speed (HS) networks and may include one or more type 2 networks 104 that may be Ethernet networks. The type 1 networks 1 102, 2 106 may support one or more of RDMA or IB protocol to provide efficient and properly routed access using a type 1 switch 116 or using type 1 routers 114, between supported type 1 host machines 1-N 120, A1-AN 124. For example, the type 1 networks 1 102, 2 106 support use of a hash-based egress port selection for communication between a supported type 1 host machines and using a type 1 router or switch 114, 116 of a type 1 fabric 118. The type 2 networks 104 support Ethernet-based protocols for communication between type 2 host machines 122 and using a type 2 switch 112. Further, there may be interconnect communications 126, 128 between the type 1 and the type 2 networks. The interconnect communications may be enabled using type 1 and type 2 gateways 108, 110 or type 2 switches 112 of provided interconnect devices 130. Such interconnect communications may be based in part on or may use RoCE or IBoE protocol.

In at least one embodiment, one or more of the interconnect devices 130, the type 1 network elements 114-118, and the type 2 switches 112, may benefit from the verification or testing of a packet processing flow performed in hardware associated with at least one network element. In one example, one or more of the interconnect devices 130, the type 1 network elements 114-118, and the type 2 switches 112 may be a network element capable of the verification or testing of a packet processing flow. While features of a network element can support hardware steering for verification and testing, this may require a large number of test cases and executing each test case under control of an associated software may take considerable time. For example, the associated software may be provided to send packets to a network element, the network element may perform an action, including to modify the packet, and the software may be required to capture an output or receive a test packet for verification that it is as expected. Generally, as used herein, the output or received test packet is also referred to as a test packet even if it is modified, as the difference and use herein is apparent from the discussion. Further, a whole input domain may be large and may include more than 2*32 test cases that require verification and testing. For example, a whole input domain may include combinations of packet headers and packet fields values resulting in a significantly large number of test cases. As a result, only a small, selected sample of the input domain may be tested, but this leaves undetected bugs in other unselected samples. Further, the selection may be random or specific. In either case, the sample will be small relative to a whole input domain. This may be further problematic in an approach requiring software involvement.

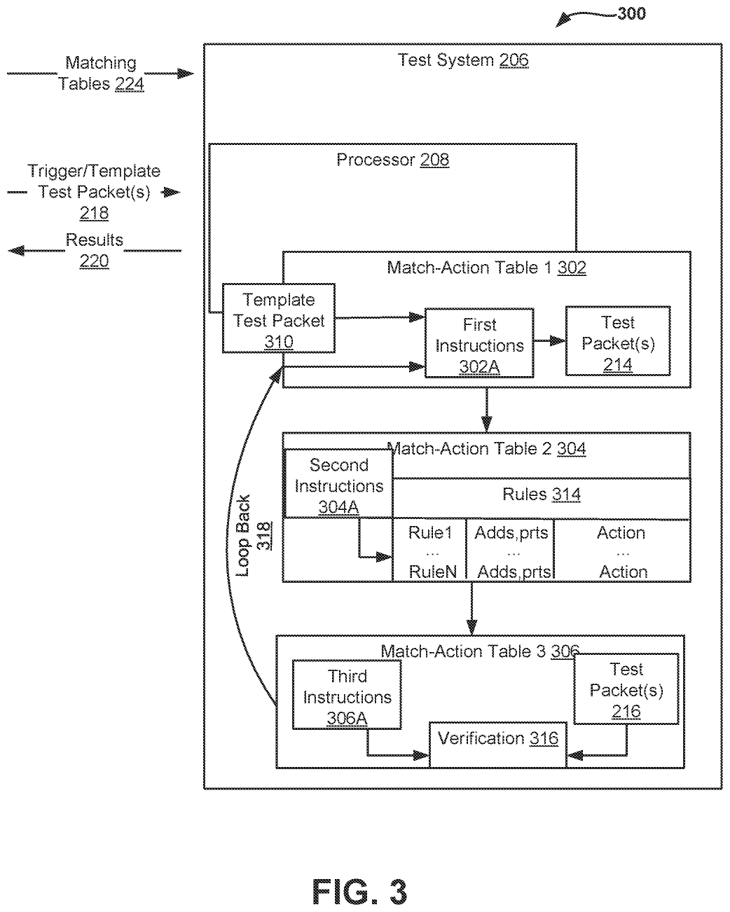

The approaches herein for verification or testing of a packet processing flow performed in hardware associated with at least one network element can address the time and processing limitations for large test cases. For example, the hardware of one or more network elements may be used to provide the hardware steering. This may include providing program instructions for a packet processing flow to be replicated in the hardware associated with the one or more network elements. In one example, the program instructions may be provided via multiple match-action or match-action tables, such as described with respect to FIGS. 1 and 3 herein. The match-action tables may include instructions for rules that select test packets by a matching criterion and that can perform actions on the test packets

In at least one embodiment, the actions may include modification of fields, dropping of packets, forwarding of packets to another table, forwarding of packets to a port, counting of packets, setting of registers associated with a packet processing flow, and other related actions. The instructions associated with the match-action tables may be coded in the format of a programming language. For example, conditional statements may be provided for the matching criterion, forward flow and loop backs instructions can transfer control between match-action tables, exit condition instructions can be provided to cause forwarding to ports, and instructions for use of persistent variables, such as to set register and to modify packet fields are also supported. One example of a programming language is P4®.

In at least one embodiment, one or more network elements and switches 112-118 herein may be used with the match-action tables to allow for the creation of a program having instructions that can be performed within the hardware of the network element. For example, at least one processor associated with a network element can perform the instructions. Therefore, verification and testing herein is able to encompass a full input domain, without involving software of a host controller, for instance. Instead, at least a trigger that may include a template test packet and a packet processing flow may be provided from a host controller, whereas, the verification and testing, with a full range of test packets and not just a sample of test packets, may be performed within the hardware of the one or more network elements. As the verification and testing is performed in the hardware, the approach herein is faster and the ability to check many different test cases by checking packet fields is established without a need to write new software to emulate any aspect implemented in the hardware of the network element.

In at least one embodiment, the at least one network element that can be used with the testing of a packet processing flow performed in hardware belongs in a type 1 network. For example, such a network element may be type 1 network interface card (NIC), a type 1 switch 116, or a type 1 router 114. The type 1 network is a high-speed network that may be managed or configured using a centralized controller (CC) or a subnet manager (SM). The CC or SM may be available within each type 1 network or subnetwork. The CC or SM is to provide configuration information to its respective type 1 switches 116 or routers 114 of all available ports across all devices of the respective network or subnetwork. The CC or SM may be combination of hardware and software or may be firmware features implemented on one type 1 switch, router, or gateway in a respective network or subnetwork, or in a type 1 host machine 1-N 120; A1-AN 124 of a respective network subnetwork.

The configuration information may be provided as forwarding tables to enable the respective type 1 switches or routers to use a hash for the determination or selection of the at least one of the available egress ports for the transmission of the data packet associated with the traffic flow, onwards from the type 1 switch or router to at least one receiving host machine or to a further routing layer. For example, the CC or SM may provide relevant portions of its configuration information to connected switches and routers to enable one or more paths in the type 1 networks. In at least one embodiment, the at least one network element that can be used with the testing of a packet processing flow performed in hardware belongs in a type 2 network. A type 2 network may use TCP/IP protocols for its routing. The TCP/IP protocols may be provided via a type 2 routers, switches, or gateways having configuration information therein to enable the features for the TCP/IP connections associated therewith.

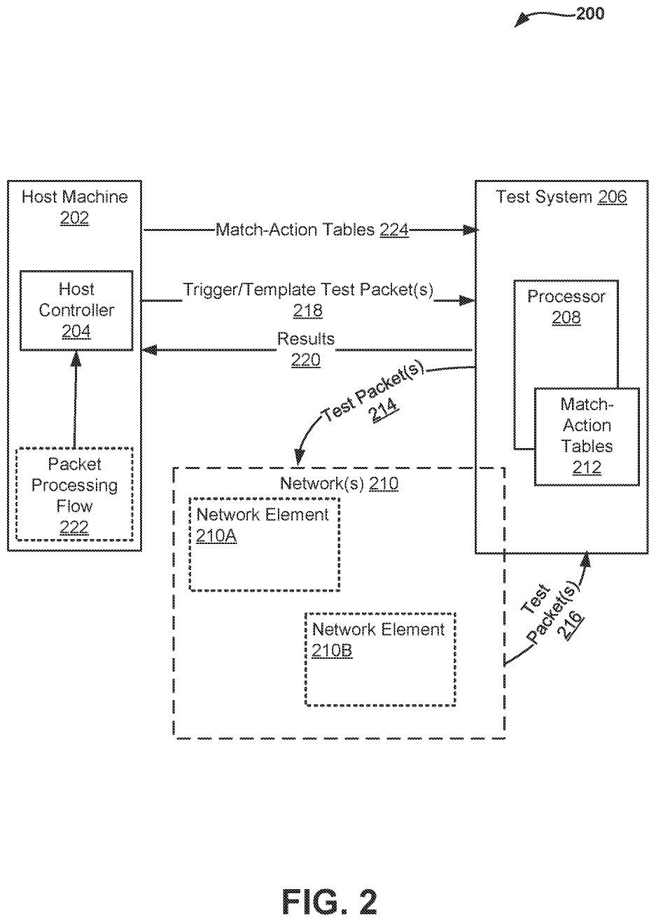

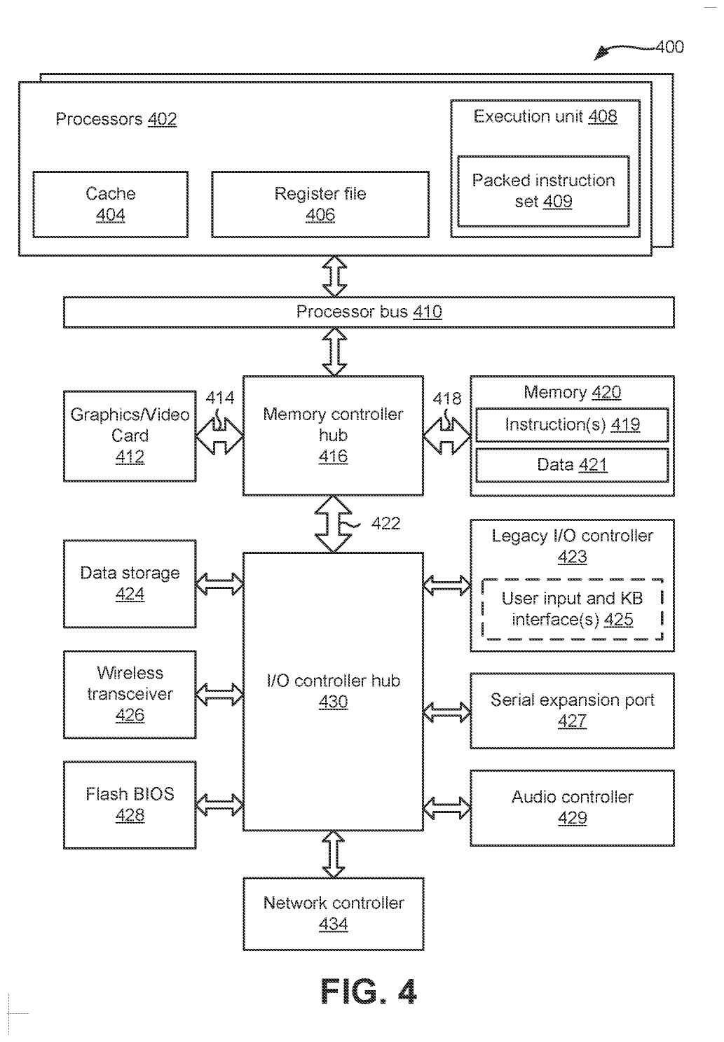

FIG. 2 illustrates aspects of a system 200 for testing of a packet processing flow performed in hardware associated with at least one network element, according to at least one embodiment. As illustrated in FIG. 2, the system 200 includes at least one host machine 202 having a host controller 204 to perform a software that can trigger or initiate the test or verification using a test system 206. The host machine 202 may be any of the host machines 1-N 120; A1-AN 124 in FIG. 1. The system 100 includes at least one execution unit that may be all or part of a processor 208. This is detailed further with respect to at least FIG. 4. The at least one execution unit may be associated with a network element 210A; 210B to perform a test of a packet processing flow 222.

In one example, there may be multiple network elements sharing the performance of the test and these multiple network elements may be part of a network(s) 210. Further, although illustrated as a test system 206, the test system 206 may itself include a network element or may be a controlling network element for performing the test. The at least one execution unit can perform instructions of a number of match-action tables 212. In one example, a first one of the match-action tables 212, as described further with respect to FIG. 3, may include first instructions for generation of test packet(s) 214 for the packet processing flow. A second one of the match-action tables 212 may include second instructions to provide rules associated with the packet processing flow that may be the packet match-action rules under test. A third one of the match-action tables 212 may include third instructions to perform verification of the test based on the rules under the test and using the test packet(s) 216.

Therefore, even though illustrated as being passed external to a test system 206, the test packet(s) 214 may be passed through the match-action tables within the one or more network elements 210A; 210B of a representative network(s) 210 to replicate, in the hardware of the network elements, what may be otherwise required in testing and verification using multiple interactions with a software of the host controller 204.

In at least one embodiment, the system 200 herein is so that the first one of the match-action tables 212 can receive a trigger and/or template test packet(s) 218 from a host controller 204 of the system 200. In one example, the trigger may include a template test packet or may be a template test packet that can enable first ones of the test packets for the packet processing flow. For example, a packet processing flow may include algorithmic logic. The packet processing flow may include a loop for generating the next packet. Results 220 of a packet processing flow may be provided from verification performed by evaluating different fields in the test packet. The fields may include fields that are part of a header and of a body section or a payload of a test packet, in one example.

In at least one embodiment, a packet processing flow 222 may be provided from a host controller 204, in the form of test packets and match-action tables, as part of the verification or test to be performed in the hardware of the test system 206. The packet processing flow may include an intended flow for the test packets within a network(s) 210 having network elements 210A; 210B. While only two are illustrated, the test packets may be used to test a path through any number of network elements and through any number of networks of any type. In an example, the packet processing flow may be used to perform the verification that the test packet(s) 216 captured perform as intended after the match-action tables 212. In one example, the packet processing flow may be used with the third one of the match-action tables 212 to verify the test packet(s) 216 captured against the test packet(s) 214 provided for the test.

In at least one embodiment, the packet processing flow 222 enables the test system 206 to provide test packets that can pass through different network infrastructure, as illustrated and described with respect to FIG. 1. As such, the packet processing flow allows testing of the infrastructure as well as allowing optimization of network performance. For example, based in part on the results 220, a network(s) 210 may be provided for data to be transmitted for overlay applications in the form of packets. Then, the packets in the network may be ensured to perform in a manner confirmed by the test or verification. The packet processing flow may be a basis for providing the template test packet of the trigger/template test packet(s) 218. In one example, the packet processing flow establishes source and destination addresses, data, and control information for a test packet. The captured test packet(s) 216 may include changes that reflect sequence of actions associated with processing and forwarding of a test packet, from a source to a destination associated with the addresses established.

In at least one embodiment, the packet processing flow may be defined in the host controller 204. The packet processing flow may be used for initiation of the test or verification by causing a template test packet to be generated from the host controller, where the template test packet may include all or part of the information for the packet processing flow. In one example, the template test packet may be encapsulated into a network protocol to suit the type 1 or type 2 networks herein. Further, in at least one embodiment, the packet processing flow 222 is a source code to be compiled on a host controller 204. The result from the compilation may be the match-action tables 212 that may be deployed to the test system 206 to execute within at least one execution unit of a processor 208 of the test system 206. A further result may be the generation of a template test packet to be provided with a trigger or to be a trigger/template test packet(s) 218 for initiating the testing or verification herein. Therefore, the at least one execution unit of a processor 208 is further to use source code or configuration associated with a packet processing flow (such as a compiled or formatted version) to generate the first one of the match-action tables, the second one of the match-action tables and the third one of the match-action tables, as detailed further with respect to FIG. 3.

FIG. 3 illustrates further aspects 300 of a test system for testing of a packet processing flow performed in hardware associated with at least one network element, according to at least one embodiment. In at least one embodiment, the match-action tables 224, which is provided and deployed from compiled source code or formatted configuration associated with the packet processing flow 222, include one or more instructions to provide test packet(s) 214 beginning from a template test packet 310. For example, the template test packet 310 may be provided from the host controller 204 to trigger (or along with a trigger) to start the testing or verification. The match-action tables 212 may include instructions to perform aspects of the test or verification as described all throughout herein.

In one example, the first one of the match-action tables 302 (illustratively marked match-action table 1) may include first instructions 302A to generate the test packet(s) 214 using the provided template test packet 310. For example, the first one of the match-action tables 302 is to receive the trigger/template test packet(s) 218 and is configured to, by at least the first instructions 302A, generate one or more test packet(s) 214 based in part on a modification of a template test packet. The modification can include a change of one or more of packet field properties, register values, or destination ports, destination match-action tables of the template test packet.

Further, instead of having to transmit the test packet from the test system 206 to different network elements, such as a router or a switch, it is possible to perform a test or verification of the rules for a packet processing flow (such as, the packet match-action rules under test) using a second one of the match-action tables (illustratively marked match-action table 2). The second one of the match-action tables 304 may include second instructions 304A to apply at least one rule that may match the test packet(s) 214 using a table of rules 314. Therefore, the second one of the match-action tables 304 may include the packet match-action rules under test. For example, a packet match-action rules under test may include a match that is based in part on the addresses or ports associated with the test packet. However, it is possible to use other ones of the fields of the test packet to perform the matching.

In at least one embodiment, the second one of the match-action tables 304 is to receive control after the test packet(s) 214 is provided to the second one of the match-action tables 304. The second instructions 304A may include using a relevant rule from the table of rules 314 that is applied to cause any action to be taken on the test packet. The actions may include modification of fields, dropping of packets, forwarding of packets to another table, forwarding of packets to a port, counting of packets, setting of registers associated with a packet processing flow, and other related actions.

In at least one embodiment, the rules of the second one of the match-action tables 304 are rules that may be otherwise associated with at least one network element in the system 100 of FIG. 1. Further, although illustrated in the test system 206 and illustrated with respect to one processor 208, the test system 206 may be associated with multiple network elements, as discussed with respect to one or more of FIG. 1 or 2. Therefore, the match-action tables may be performed across different hardware of such different network elements. In any case, the match-action tables allow the test system 206 to perform test and verification in hardware without ongoing interfaces with the host controller, other than the trigger, the results, and the initial provision of the match-action tables for execution with the processor 208.

In at least one embodiment, the actions may pertain to policy application, filtering, or classification, to enable treatment and forwarding of the test packet through a network for the test and verification purposes. The actions can cause modifications to a payload or a header of test packet but maintain the test packet status for the test and verification. Based in part on the applicable rules, the test packet may be forwarded or processed as if within one or more different network elements of a network path. In at least one embodiment, the second instructions 304A are able to apply rules that may include examination of a destination address, determining next hops, and updating a header or payload of the test packet to suit the applied rules. Further, all such rules may be based in part on the packet processing flow 222 determined for the test or the verification. However, it is possible to retain the same packet processing flow 222 for different types of tests so long as all possible actions and rules are covered, in at least one embodiment.

In at least one embodiment, the rules of the table of rules 314 may be such that multiple rules may apply as the test packet is transitioned through different hops of a network, to replicate a network path. This may include directions through ports for ingress, forwarding, and egress through a network. As these steps occur, there may be entries in the table of rules 314 that are directed to network actions such as, for load balancing, resource utilization, traffic shaping, queuing for prioritization, bandwidth limitations, tunneling, or for other networking protocols as needed, according to the packet processing flow 222. These protocols may cause changes to the test packet(s) 214, as initially generated, as if the test packet(s) 214 has passed through multiple network elements 210A, 210B of a network(s) 210. The resulting test packet(s) 216 may be captured for verification.

In at least one embodiment, the third one of the match-action tables 306 (illustratively marked match-action table 3) is able to receive control after the resulting test packet(s) 216 is captured or transferred to the third one of the match-action tables 306. Further, while illustrated in the singular, there may be multiple test packet(s) 216 captured prior to performing the verification 316, although it is possible to perform verification 316 of each received test packet(s) 216. Therefore, the third instructions 306A may cause a verification 316 to be performed to determine that the resulting test packet(s) 216 is as expected. For example, the third instructions 306A may cause the verification 316 to be with respect to a count for a number of test packet(s) 216 that match within a table verification of the packet match rules. In addition, in at least some instances, the initial test packet(s) and table of rules 314 may be available to the third one of the match-action tables 306 to perform the verification.

In one example, the verification is as to a match in the packet format between the test packet(s) 214, 216, as sent and as received. The third one of the match-action tables 306 can be caused to perform a cyclic action by a loop back 318 or looping back of control from the third one of the match-action tables 306 to the first one of the match-action tables 302. This may be for the test system 206 to generate a next test packet. However, if a test or verification is complete by an indication within the system herein, then a further indication of success or failure can be returned, as part of the results 220, to the host controller. As the packet processing flow may be specific to a verification or test to be performed, the results 220 may be pertinent to the verification or the test for that packet processing flow. The test may also include capability, in at least part of the first, second, and third instructions 302A, 304A, 306A, for conditional actions. This may be used to transfer control between the match-action tables 212.

In at least one embodiment, the match-action tables 302-306 may be provided to separately perform instructions 302A-306A using stored information associated with the template test packet, the test packet, the table of rules 314, and the verification 316. However, it is appreciated that one or more of instructions 302A-306A provide the function without a separation as illustrated in FIG. 3, for instance. In one example, the third instructions 306A performs the verification without a separate verification 316 feature, but the verification 316 may include stored information to be used to complete the verification. In at least one embodiment, the third instructions 306A can be used to perform the verification of the test by a verification of one or more of a register value, an output port, or packet field properties that were modified or caused using one of the second instructions 304A pertaining to the table of rules 314. The third instructions 306A indicate the results 220 of the verification of the test to a host controller 204.

In at least one embodiment, therefore, the first one of the match-action tables 302 may be able to generate a full coverage of packets field properties for the test by the test packet(s) 214 provided. The test packets can be forwarded to the second one of the match-action tables 304 for application of the rules 314. The test packets can be forwarded, even if modified or replaced by a corresponding modified version, to the third one of the match-action tables 306 for the verification. Individual one of the captured test packet(s) 216 or prior test packet(s) 214 may be looped back 318 to the first one of the match-action tables 302 from the third one of the match-action tables 306. However, it is possible to retain a captured test packet(s) 216 or prior test packet(s) 214 that remains associated with the first one of the match-action tables 302. Further, a subsequent one of the test packets is generated based in part on the individual one of the test packets 214. However, it is possible to store and use the previously provided test packets to generate new or next test packets.

In at least one embodiment, aspects of the match-action tables 212 may be limited by capabilities of the at least one execution unit of a processor 208. Then, further hardware of the test system 206, such as belonging to other network elements may be used to generate the test packets, to provide the rules associated with the packet processing flow, and to perform the verification of the test based on the rules under the test and using the test packets. Therefore, even though illustrated with respect to a singular processor 208, the test system 206 may be associated with multiple processors 208 in a shared or parallel processing operation.

In at least one embodiment, the host controller 204 may be associated with source code or configuration for the packet processing flow, as received through an interface of a host machine 202. For example, for a series of tests or verifications to be performed, it is possible to receive a packet processing flow that defines at least one or more template test packets, modifications to be made to the template test packets for further test packets, different rules to be deployed in a match-action table, and verification or test procedures to be followed in another match-action table. The source code or configuration may be able to format the packet processing flow to the different match-action tables. The packet processing flow is, therefore, a definition of at least what is intended to be tested in a test system 206. Similarly, once complied or formatted, the source code or configuration is to provide at least the rules of the second one of the match-action tables for the network element.

As such, the source code or configuration can be used to generate the first one of the match tables to enable the generation of the test packets or can be used to generate the third one of the match-action tables to enable the verification of the test packets based on the rules under test. The host machine 202 may include the one or more interfaces that may be associated with the host controller 204 to receive source code or configuration based in part on the packet processing flow to be tested and to receive a result 220 from the verification of the test. The source code or configuration, once complied or applied in a pertinent format for the test system 206, can provide the instructions 302A-306A for the network element 210A; 210B.

Therefore, the host controller 204 herein can enable a network element 210A; 210B to perform a test of packet processing flow in a network(s) 210. The host controller 204 can provide a trigger to at least one circuit, such as of the processor 208, to cause the at least one circuit to perform instructions of the match-action tables 212. As described with respect to aspects in FIGS. 2 and 3, a first one of the match-action tables can include first instructions for generation of test packets for the packet processing flow. A second one of the match-action tables can include second instructions to provide rules associated with the packet processing flow. Further, a third one of the match-action tables can include third instructions to perform verification of the test based on the rules under test and using the test packets. The processor is able to perform the instructions by a change in control, in a cyclic manner, from each match-action table as a respective function of the match-action table is completed. The host controller 204 is also enabled for one or more of receiving an indication of a result of the verification of the test, providing an interface to receive the source code or configuration that is based in part on the packet processing flow to be tested, or storing source code or configuration based in part on the packet processing flow to be tested.

FIG. 4 illustrates computer aspects 400 for testing of a packet processing flow performed in hardware associated with at least one network element, according to at least one embodiment. For example, each of the illustrated processors 402 may include one or more processing or execution units 408 that can perform any or all of the aspects of the system 100 or the test system 206 as part of a host machine of FIGS. 1-3 or part of a host machine, a NIC, a router, a switch, or a gateway of FIGS. 1-3.

The processing or execution units 408 may include multiple circuits to support the aspects described herein for testing of a packet processing flow performed in hardware associated with at least one network element. In at least one embodiment, the processors 402 may include CPUs, GPUs, DPUs that may be associated with a host machine, a NIC, a router, a switch, or a gateway of FIGS. 1-3. Further, the GPUs may be distinctly in distinct graphics/video cards 412, relative to a DPU that may be part of a NIC (represented by a network controller 434) and a CPU represented by the processors 402 illustrated in FIG. 4. Therefore, even though described in the singular, the graphics/video card 412 may include multiple cards and may include multiple GPUs on each card that are capable of communications using the protocols of the type 1 devices in FIGS. 1-3.

The computer and processor aspects 400 may be performed by one or more processors 402 that include a system-on-a-chip (SOC) or some combination thereof formed with a processor that may include execution units to execute an instruction, according to at least one embodiment. In at least one embodiment, the computer and processor aspects 400 may include, without limitation, a component, such as a processor 402 to employ execution units 408 including logic to perform algorithms for process data, in accordance with present disclosure, such as in embodiment described herein. In at least one embodiment, the computer and processor aspects 400 may include processors, such as PENTIUM® Processor family, Xeon™, Itanium®, XScale™ and/or StrongARM™, Intel® Core™, or Intel® Nervana™ microprocessors available from Intel Corporation of Santa Clara, California, although other systems (including PCs having other microprocessors, engineering workstations, set-top boxes and like) may also be used. In at least one embodiment, the computer and processor aspects 400 may execute a version of WINDOWS operating system available from Microsoft Corporation of Redmond, Wash., although other operating systems (UNIX and Linux, for example), embedded software, and/or graphical user interfaces, may also be used.

Embodiments may be used in other devices such as handheld devices and embedded applications. Some examples of handheld devices include cellular phones, Internet Protocol devices, digital cameras, personal digital assistants (“PDAs”), and handheld PCs. In at least one embodiment, embedded applications may include a microcontroller, a digital signal processor (“DSP”), system on a chip, network computers (“NetPCs”), set-top boxes, network hubs, wide area network (“WAN”) switches, or any other system that may perform one or more instructions in accordance with at least one embodiment.

In at least one embodiment, the computer and processor aspects 400 may include, without limitation, a processor 402 that may include, without limitation, one or more execution units 408 to perform aspects according to techniques described with respect to at least one or more of FIGS. 1-3 and 5-7 herein. In at least one embodiment, the computer and processor aspects 400 is a single processor desktop or server system, but in another embodiment, the computer and processor aspects 400 may be a multiprocessor system.

In at least one embodiment, the processor 402 may include, without limitation, a complex instruction set computer (“CISC”) microprocessor, a reduced instruction set computing (“RISC”) microprocessor, a very long instruction word (“VLIW”) microprocessor, a processor implementing a combination of instruction sets, or any other processor device, such as a digital signal processor, for example. In at least one embodiment, a processor 402 may be coupled to a processor bus 410 that may transmit data signals between processors 402 and other components in computer and processor aspects 400.

In at least one embodiment, a processor 402 may include, without limitation, a Level 1 (“L1”) internal cache memory (“cache”) 404. In at least one embodiment, a processor 402 may have a single internal cache or multiple levels of internal cache. In at least one embodiment, cache memory may reside external to a processor 402. Other embodiments may also include a combination of both internal and external caches depending on particular implementation and needs. In at least one embodiment, a register file 406 may store different types of data in various registers including, without limitation, integer registers, floating point registers, status registers, and an instruction pointer register.

In at least one embodiment, an execution unit 408, including, without limitation, logic to perform integer and floating point operations, also resides in a processor 402. In at least one embodiment, a processor 402 may also include a microcode (“ucode”) read only memory (“ROM”) that stores microcode for certain macro instructions. In at least one embodiment, an execution unit 408 may include logic to handle a packed instruction set 409.

In at least one embodiment, by including a packed instruction set 409 in an instruction set of a general-purpose processor, along with associated circuitry to execute instructions, operations used by many multimedia applications may be performed using packed data in a processor 402. In at least one embodiment, many multimedia applications may be accelerated and executed more efficiently by using a full width of a processor's data bus for performing operations on packed data, which may eliminate a need to transfer smaller units of data across that processor's data bus to perform one or more operations one data element at a time.

In at least one embodiment, an execution unit 408 may also be used in microcontrollers, embedded processors, graphics devices, DSPs, and other types of logic circuits. In at least one embodiment, the computer and processor aspects 400 may include, without limitation, a memory 420. In at least one embodiment, a memory 420 may be a Dynamic Random Access Memory (“DRAM”) device, a Static Random Access Memory (“SRAM”) device, a flash memory device, or another memory device. In at least one embodiment, a memory 420 may store instruction(s) 419 and/or data 421 represented by data signals that may be executed by a processor 402.

In at least one embodiment, a system logic chip may be coupled to a processor bus 410 and a memory 420. In at least one embodiment, a system logic chip may include, without limitation, a memory controller hub (“MCH”) 416, and processors 402 may communicate with MCH 416 via processor bus 410. In at least one embodiment, an MCH 416 may provide a high bandwidth memory path 418 to a memory 420 for instruction and data storage and for storage of graphics commands, data, and textures. In at least one embodiment, an MCH 416 may direct data signals between a processor 402, a memory 420, and other components in the computer and processor aspects 400 and to bridge data signals between a processor bus 410, a memory 420, and a system I/O interface 422. In at least one embodiment, a system logic chip may provide a graphics port for coupling to a graphics controller. In at least one embodiment, an MCH 416 may be coupled to a memory 420 through a high bandwidth memory path 418 and a graphics/video card 412 may be coupled to an MCH 416 through an Accelerated Graphics Port (“AGP”) interconnect 414. In at least one embodiment, the graphics/video card 412 may be coupled to one or more of the processors 402 via a PCIe interconnect standard. Similarly, a network controller 424 may also be coupled to one or more of the processors 402 via a PCIe interconnect standard.

In at least one embodiment, the computer and processor aspects 400 may use a system I/O interface 422 as a proprietary hub interface bus to couple an MCH 416 to an I/O controller hub (“ICH”) 430. In at least one embodiment, an ICH 430 may provide direct connections to some I/O devices via a local I/O bus. In at least one embodiment, a local I/O bus may include, without limitation, a high-speed I/O bus for connecting peripherals to a memory 420, a chipset, and processors 402. Examples may include, without limitation, an audio controller 429, a firmware hub (“flash BIOS”) 428, a wireless transceiver 426, a data storage 424, a legacy I/O controller 423 containing user input and keyboard interface(s) 425, a serial expansion port 427, such as a Universal Serial Bus (“USB”) port, and a network controller 434. In at least one embodiment, data storage 424 may comprise a hard disk drive, a floppy disk drive, a CD-ROM device, a flash memory device, or other mass storage device.

In at least one embodiment, FIG. 4 illustrates computer and processor aspects 400, which includes interconnected hardware devices or “chips”, whereas in other embodiments, FIG. 4 may illustrate an exemplary SoC. In at least one embodiment, devices illustrated in FIG. 4 may be interconnected with proprietary interconnects, standardized interconnects (e.g., PCIe) or some combination thereof. In at least one embodiment, one or more components of the computer and processor aspects 400 that are interconnected using compute express link (CXL) interconnects.

Therefore, the at least one execution unit 408 may be a circuit of at least one processor 402 can be associated with a host machine, a NIC, a router, a switch, or a gateway. At least the NIC, router, switch, or gateway which may each be, or which may each support or provide a network element, also described with respect to one or more of FIGS. 1-3. In one example, the at least one circuit can be associated with a host controller and can enable a network element to perform a test of packet processing flow in a network. The at least one circuit can perform instructions of different match-action tables. A first one of the match-action tables may include first instructions for generation of test packets for the packet processing flow. A second one of the match-action tables may include second instructions to provide rules associated with the packet processing flow under test. A third one of the match-action tables may include third instructions to perform verification of the test based on the rules under the test and using the test packets

Further, the at least one circuit of the computer aspects 400 is such that it is further able to process source code or configuration in the host controller. For example, the process may be to compile or to apply a format for a source code or configuration that is associated with a packet processing flow. As such the processed source code or configuration is further to provide the rules, based in part on the source code or configuration. The rules to be part of the second one of the match-action tables, for instance. In addition, the at least one circuit of the computer aspects 400 is such that the source code or configuration is also able to be used to generate the first one of the match tables to enable the generation of the test packets. Still further, the source code or configuration is also able to be used to generate the third one of the match-action tables to enable the verification of the test packets based on the rules under the test.

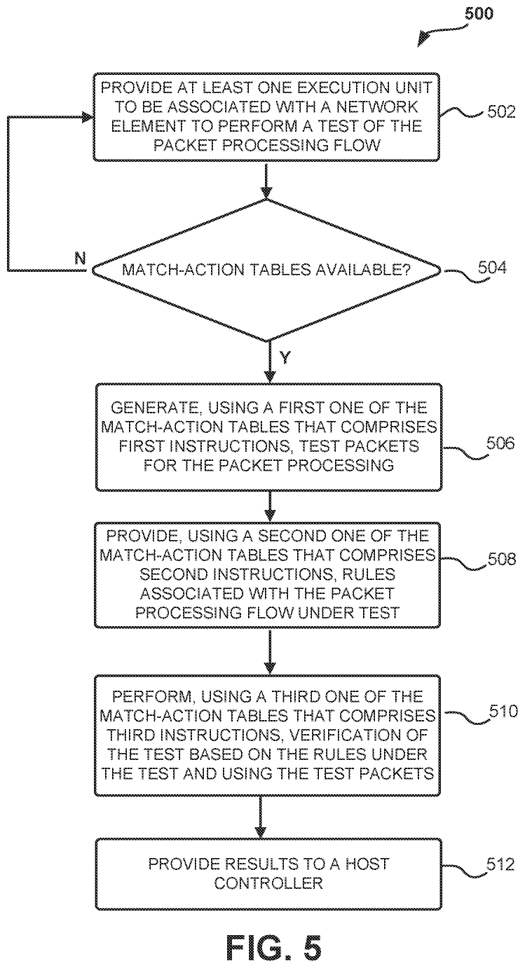

FIG. 5 illustrates a process flow or method 500 for testing a packet processing flow for a network element, according to at least one embodiment. The method 500 includes providing 502 at least one execution unit to be associated with the network element to perform the test of the packet processing flow by performing instructions of different match-action tables. The method 500 includes verifying that the match-action tables are available 504 to perform the test. For example, the match-action tables may be deployed from a host controller. The verification may include allowing the deploying by installation or transfer of compiled source code or applied format of a configuration associated with a packet processing flow.

The method 500 includes generating 506, using a first one of the match-action tables that includes first instructions, test packets for the packet processing flow. The method 500 includes providing 508, using a second one of the match-action tables that includes second instructions, rules associated with the packet processing flow under test. The method 500 includes performing 510, using a third one of the match-action tables that includes third instructions, verification of the test based on the rules under the test and using the test packets. A further providing 512 step may be performed for returning results from the verification of the test to the host controller.

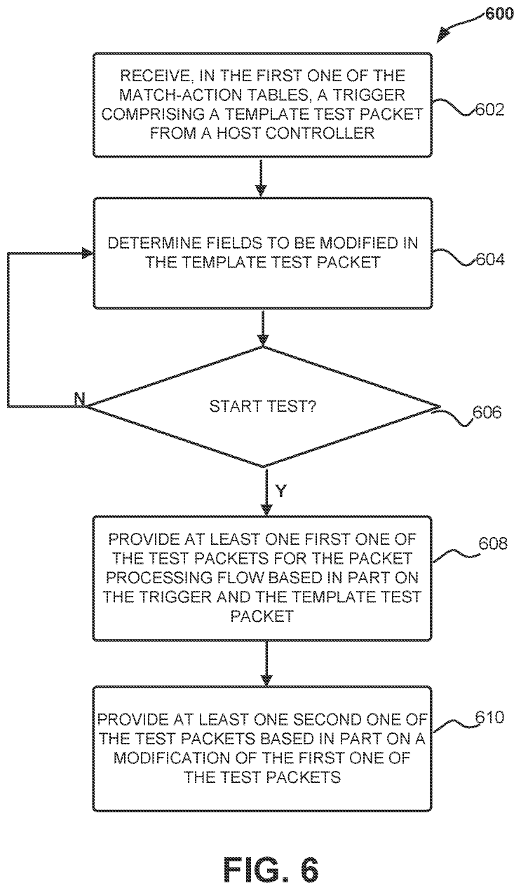

FIG. 6 illustrates a further process flow or method 600 for testing a packet processing flow for a network element, according to at least one embodiment. The method 600 may be performed in support or distinctly from the method 500 of FIG. 5. The method 600 in FIG. 6 includes receiving 602, in the first one of the match-action tables, a trigger having a template test packet from a host controller. In at least one embodiment, the trigger is the template test packet. The method 600 includes determining 604 fields to be modified in the template test packet, by the first one of the match-action tables. For example, based in part on a packet processing flow, the first instructions of the first one of the match-action tables can modify or change one or more properties or fields that may include fields that are part of a header or a payload of the template test packet to generate the test packet. It is also possible to use the template test packet as at least a first test packet, with subsequent modifications or changes to generate subsequent test packets.

The method 600 includes verifying 606 to start the test, which may be performed by first ensuring that the match-action tables are installed or deployed and that the test packet(s) are ready for the test. The method 600 includes providing 608, to the second one of the match-action tables, at least one first one of the test packets for the packet processing flow based in part on the trigger and the template test packet. The method 600 includes providing 610, to the second one of the match-action tables, at least one second one of the test packets based in part on a modification of the first one of the test packets. In one example, the first one and the second one of the test packets may be generated to be concurrently or subsequently provided to the second one of the match-action tables for application of the rules prior to transfer of control to the second one of the match-action tables. In another example, the first one and the second one of the test packets may be generated to be concurrently or subsequently provided to the second one of the match-action tables for application of the rules in a cycle or sequence so that one test packet is provided at a time and a transfer of control to the second one of the match-action tables is provided with each transferred test packet.

In at least one embodiment, one or more of the steps in the method 600 of FIG. 6 may include a step or sub-step of receiving, in the first one of the match-action tables, a trigger that includes or is a template test packet from a host controller. The one or more of the steps in the method 600 of FIG. 6 may include a step or sub-step of generating, using the first one of the match-action tables, the test packets based in part on the trigger and the template test packet. The generating may include providing the template packet as a first one of the test packets and may include modifying packet field properties, register values, or destination ports of the template test packet to provide a second one of the test packets. Further, the cycle or sequence is such that a cycle back is implicitly supported where transfer of control occurs to the first match-rules table for generating the next test packet.

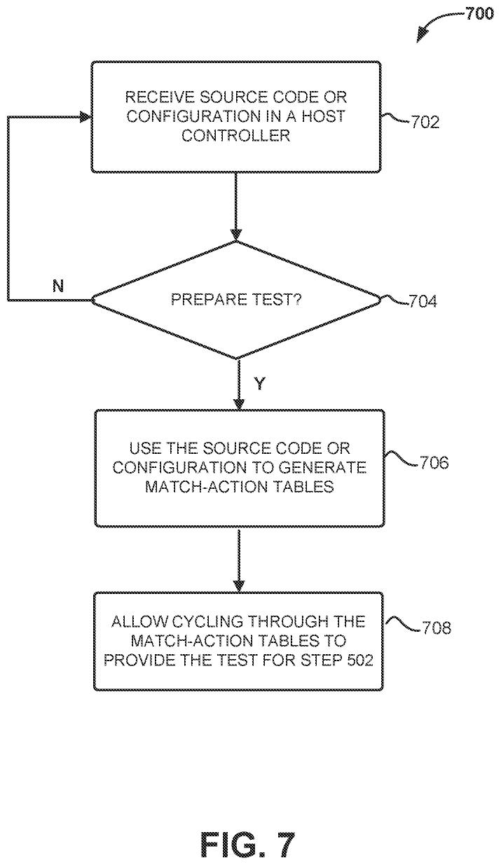

FIG. 7 illustrates yet another process flow or method 700 for testing a packet processing flow for a network element, according to at least one embodiment. Like in the case of the method 600 in FIG. 6, the method 700 in FIG. 7 may be performed in support or distinctly from the methods 500, 600 of FIGS. 5 and 6. The method 700 in FIG. 7 includes receiving 702 source code or a configuration via an interface of a host controller. A verification 704 to prepare for testing may be performed, such as by standing by for a compiling or formatting instruction. For example, the source code or configuration may be received in the host controller that can compile it or apply formatting to generate a template test packet and to generate 706 the match-action tables. The method 700 of FIG. 7 may include allowing 708 a cycling through the match-action tables, such as by transferring control from the first one of the match-action tables to the second one of the match-action tables to apply the rules for the testing, and by transferring control from the second one of the match-action tables to the third one of the match-action tables to perform verification of the test and to provide the results. Therefore, aspects of the method 700 in FIG. 7, such as the allowing 708 step, may be used to provide the test for at least the step 502 in FIG. 5, which is to enable performance of the test of the packet processing flow, where instructions of different match-action tables are performed as part of the test.

Other variations are within spirit of present disclosure. Thus, while disclosed techniques are susceptible to various modifications and alternative constructions, certain illustrated embodiments thereof are shown in drawings and have been described above in detail. It should be understood, however, that there is no intention to limit disclosure to specific form or forms disclosed, but on contrary, intention is to cover all modifications, alternative constructions, and equivalents falling within spirit and scope of disclosure, as defined in appended claims.

Use of terms “a” and “an” and “the” and similar referents in context of describing disclosed embodiments (especially in context of following claims) are to be construed to cover both singular and plural, unless otherwise indicated herein or clearly contradicted by context, and not as a definition of a term. Terms “comprising,” “having,” “including,” and “containing” are to be construed as open-ended terms (meaning “including, but not limited to,”) unless otherwise noted. “Connected,” when unmodified and referring to physical connections, is to be construed as partly or wholly contained within, attached to, or joined together, even if there is something intervening. Recitation of ranges of values herein are merely intended to serve as a shorthand method of referring individually to each separate value falling within range, unless otherwise indicated herein and each separate value is incorporated into specification as if it were individually recited herein. In at least one embodiment, use of term “set” (e.g., “a set of items”) or “subset” unless otherwise noted or contradicted by context, is to be construed as a nonempty collection comprising one or more members. Further, unless otherwise noted or contradicted by context, term “subset” of a corresponding set does not necessarily denote a proper subset of corresponding set, but subset and corresponding set may be equal.

Conjunctive language, such as phrases of form “at least one of A, B, and C,” or “at least one of A, B and C,” unless specifically stated otherwise or otherwise clearly contradicted by context, is otherwise understood with context as used in general to present that an item, term, etc., may be either A or B or C, or any nonempty subset of set of A and B and C. For instance, in illustrative example of a set having three members, conjunctive phrases “at least one of A, B, and C” and “at least one of A, B and C” refer to any of following sets: {A}, {B}, {C}, {A, B}, {A, C}, {B, C}, {A, B, C}. Thus, such conjunctive language is not generally intended to imply that certain embodiments require at least one of A, at least one of B and at least one of C each to be present. In addition, unless otherwise noted or contradicted by context, term “plurality” indicates a state of being plural (e.g., “a plurality of items” indicates multiple items). In at least one embodiment, number of items in a plurality is at least two, but can be more when so indicated either explicitly or by context. Further, unless stated otherwise or otherwise clear from context, phrase “based on” means “based at least in part on” and not “based solely on.”

Operations of processes described herein can be performed in any suitable order unless otherwise indicated herein or otherwise clearly contradicted by context. In at least one embodiment, a process such as those processes described herein (or variations and/or combinations thereof) is performed under control of one or more computer systems configured with executable instructions and is implemented as code (e.g., executable instructions, one or more computer programs or one or more applications) executing collectively on one or more processors, by hardware or combinations thereof. In at least one embodiment, code is stored on a computer-readable storage medium, for example, in form of a computer program comprising a plurality of instructions executable by one or more processors.

In at least one embodiment, a computer-readable storage medium is a non-transitory computer-readable storage medium that excludes transitory signals (e.g., a propagating transient electric or electromagnetic transmission) but includes non-transitory data storage circuitry (e.g., buffers, cache, and queues) within transceivers of transitory signals. In at least one embodiment, code (e.g., executable code or source code) is stored on a set of one or more non-transitory computer-readable storage media having stored thereon executable instructions (or other memory to store executable instructions) that, when executed (i.e., as a result of being executed) by one or more processors of a computer system, cause computer system to perform operations described herein. In at least one embodiment, set of non-transitory computer-readable storage media comprises multiple non-transitory computer-readable storage media and one or more of individual non-transitory storage media of multiple non-transitory computer-readable storage media lack all of code while multiple non-transitory computer-readable storage media collectively store all of code. In at least one embodiment, executable instructions are executed such that different instructions are executed by different processors—for example, a non-transitory computer-readable storage medium store instructions and a main central processing unit (“CPU”) executes some of instructions while a graphics processing unit (“GPU”) executes other instructions. In at least one embodiment, different components of a computer system have separate processors and different processors execute different subsets of instructions.

In at least one embodiment, an arithmetic logic unit is a set of combinational logic circuitry that takes one or more inputs to produce a result. In at least one embodiment, an arithmetic logic unit is used by a processor to implement mathematical operation such as addition, subtraction, or multiplication. In at least one embodiment, an arithmetic logic unit is used to implement logical operations such as logical AND/OR or XOR. In at least one embodiment, an arithmetic logic unit is stateless, and made from physical switching components such as semiconductor transistors arranged to form logical gates. In at least one embodiment, an arithmetic logic unit may operate internally as a stateful logic circuit with an associated clock. In at least one embodiment, an arithmetic logic unit may be constructed as an asynchronous logic circuit with an internal state not maintained in an associated register set. In at least one embodiment, an arithmetic logic unit is used by a processor to combine operands stored in one or more registers of the processor and produce an output that can be stored by the processor in another register or a memory location.

In at least one embodiment, as a result of processing an instruction retrieved by the processor, the processor presents one or more inputs or operands to an arithmetic logic unit, causing the arithmetic logic unit to produce a result based at least in part on an instruction code provided to inputs of the arithmetic logic unit. In at least one embodiment, the instruction codes provided by the processor to the ALU are based at least in part on the instruction executed by the processor. In at least one embodiment combinational logic in the ALU processes the inputs and produces an output which is placed on a bus within the processor. In at least one embodiment, the processor selects a destination register, memory location, output device, or output storage location on the output bus so that clocking the processor causes the results produced by the ALU to be sent to the desired location.

Accordingly, in at least one embodiment, computer systems are configured to implement one or more services that singly or collectively perform operations of processes described herein and such computer systems are configured with applicable hardware and/or software that allow performance of operations. Further, a computer system that implements at least one embodiment of present disclosure is a single device and, in another embodiment, is a distributed computer system comprising multiple devices that operate differently such that distributed computer system performs operations described herein and such that a single device does not perform all operations.

Use of any and all examples, or exemplary language (e.g., “such as”) provided herein, is intended merely to better illuminate embodiments of disclosure and does not pose a limitation on scope of disclosure unless otherwise claimed. No language in specification should be construed as indicating any non-claimed element as essential to practice of disclosure.

In description and claims, terms “coupled” and “connected,” along with their derivatives, may be used. It should be understood that these terms may be not intended as synonyms for each other. Rather, in particular examples, “connected” or “coupled” may be used to indicate that two or more elements are in direct or indirect physical or electrical contact with each other. “Coupled” may also mean that two or more elements are not in direct contact with each other, but yet still co-operate or interact with each other.

Unless specifically stated otherwise, it may be appreciated that throughout specification terms such as “processing,” “computing,” “calculating,” “determining,” or like, refer to action and/or processes of a computer or computing system, or similar electronic computing device, that manipulate and/or transform data represented as physical, such as electronic, quantities within computing system's registers and/or memories into other data similarly represented as physical quantities within computing system's memories, registers or other such information storage, transmission or display devices.

In a similar manner, term “processor” may refer to any device or portion of a device that processes electronic data from registers and/or memory and transform that electronic data into other electronic data that may be stored in registers and/or memory. As non-limiting examples, “processor” may be a CPU or a GPU. A “computing platform” may comprise one or more processors. As used herein, “software” processes may include, for example, software and/or hardware entities that perform work over time, such as tasks, threads, and intelligent agents. Also, each process may refer to multiple processes, for carrying out instructions in sequence or in parallel, continuously or intermittently. In at least one embodiment, terms “system” and “method” are used herein interchangeably insofar as system may embody one or more methods and methods may be considered a system.

In present document, references may be made to obtaining, acquiring, receiving, or inputting analog or digital data into a subsystem, computer system, or computer-implemented machine. In at least one embodiment, process of obtaining, acquiring, receiving, or inputting analog and digital data can be accomplished in a variety of ways such as by receiving data as a parameter of a function call or a call to an application programming interface. In at least one embodiment, processes of obtaining, acquiring, receiving, or inputting analog or digital data can be accomplished by transferring data via a serial or parallel interface. In at least one embodiment, processes of obtaining, acquiring, receiving, or inputting analog or digital data can be accomplished by transferring data via a computer network from providing entity to acquiring entity. References may also be made to providing, outputting, transmitting, sending, or presenting analog or digital data. In at least one embodiment, processes of providing, outputting, transmitting, sending, or presenting analog or digital data can be accomplished by transferring data as an input or output parameter of a function call, a parameter of an application programming interface or interprocess communication mechanism.

Although descriptions herein set forth example implementations of described techniques, other architectures may be used to implement described functionality, and are intended to be within scope of this disclosure. Furthermore, although specific distributions of responsibilities may be defined above for purposes of description, various functions and responsibilities might be distributed and divided in different ways, depending on circumstances.

Furthermore, although subject matter has been described in language specific to structural features and/or methodological acts, it is to be understood that subject matter claimed in appended claims is not necessarily limited to specific features or acts described. Rather, specific features and acts are disclosed as exemplary forms of implementing the claims.

What is claimed is:

1. A system comprising at least one execution unit and associated with a network element to perform a test of a packet processing flow, the at least one execution unit to perform instructions of a plurality of match-action tables, wherein a first one of the match-action tables comprises first instructions for generation of test packets for the packet processing flow, a second one of the match-action tables comprises second instructions to provide rules under test associated with the packet processing flow under test, and a third one of the match-action tables comprises third instructions to perform verification of the test based on the rules under test and using the test packets.

2. The system of claim 1, wherein the first one of the match-action tables is to receive a trigger from a host controller of the system, the trigger comprising a template test packet to enable first ones of the test packets for the packet processing flow.

3. The system of claim 1, wherein the test comprises capability, in at least part of the instructions, for conditional actions to transfer control between the plurality of match-action tables.

4. The system of claim 1, wherein the at least one execution unit is further to use source code or configuration associated with a packet processing flow to generate the first one of the match-action tables, the second one of the match-action tables and the third one of the match-action tables.

5. The system of claim 1, wherein the first one of the match-action tables is to receive a trigger and is configured to generate the test packets based in part on a modification of a template test packet, the modification to change one or more of packet field properties, register values, or destination ports, destination match-action tables of the template test packet.

6. The system of claim 1, wherein the third instructions to perform the verification of the test is to verify one or more of a register value, an output port, or packet field properties that may be modified using one of the second instructions and is to indicate a result of the verification of the test to a host controller.

7. The system of claim 1, wherein the first one of the match-action tables is to generate a full coverage of packets field properties for the test by the test packets, wherein the test packets are to be forwarded to the second one of the match-action tables for application of the rules, and wherein the test packets are to be forwarded to the third one of the match-action tables for the verification.

8. The system of claim 1, wherein an individual one of the test packets is looped back to the first one of the match-action tables from the third one of the match-action tables, and wherein a subsequent one of the test packets is generated based in part on the individual one of the test packets.

9. The system of claim 1, wherein aspects of the plurality of the match-action tables are limited by capabilities of the at least one execution unit and further hardware of the system is used to generate the test packets, to provide the rules associated with the packet processing flow, and to perform the verification of the test based on the rules under the test and using the test packets.

10. The system of claim 1, further comprising:
a host controller to be associated with source code or configuration that is based in part on a packet processing flow to be tested, the source code or configuration to provide at least the rules of the second one of the match-action tables for the network element.

11. The system of claim 1, wherein the source code or configuration is also used to generate the first one of the match tables to enable the generation of the test packets or is also used to generate the third one of the match-action tables to enable the verification of the test packets based on the rules under the test.

12. The system of claim 1, further comprising:
one or more interfaces associated with a host controller to receive source code or configuration based in part on the packet processing flow to be tested and to receive a result from the verification of the test, wherein the source code or configuration, once complied or applied provide the instructions for the network element.

13. At least one circuit to be associated with a host controller and to enable a network element to perform a test of packet processing flow in a network, the at least one circuit to perform instructions of a plurality of match-action tables, wherein a first one of the match-action tables comprises first instructions for generation of test packets for the packet processing flow, a second one of the match-action tables comprises second instructions to provide rules associated with the packet processing flow, and a third one of the match-action tables comprises third instructions to perform verification of the test based on the rules under the test and using the test packets.

14. The at least one circuit of claim 13, wherein the at least one circuit is further to process source code or configuration in the host controller, is further to provide the rules, based in part on the source code or configuration, the rules to be part of the second one of the match-action tables.

15. The at least one circuit of claim 14, wherein the source code or configuration is also used to generate the first one of the match tables to enable the generation of the test packets, or is also used to generate the third one of the match-action tables to enable the verification of the test packets based on the rules under the test.

16. A host controller to enable a network element to perform a test of packet processing flow in a network, the host controller to provide a trigger to at least one circuit to cause the at least one circuit to perform instructions of a plurality of match-action tables, wherein a first one of the match-action tables comprises first instructions for generation of test packets for the packet processing flow, a second one of the match-action tables comprises second instructions to provide rules associated with the packet processing flow, and a third one of the match-action tables comprises third instructions to perform verification of the test based on the rules under the test and using the test packets.

17. The host controller of claim 16, wherein the host controller is further enabled for one or more of: receiving an indication of a result of the verification of the test, providing an interface to receive the source code or configuration that is based in part on the packet processing flow to be tested, or storing source code or configuration based in part on the packet processing flow to be tested.

18. A method for testing a packet processing flow for a network element, the method comprising:
providing at least one execution unit to be associated with the network element to perform a test of the packet processing flow by performing instructions of a plurality of match-action tables;
generating, using a first one of the match-action tables that comprises first instructions, test packets for the packet processing flow;
providing, using a second one of the match-action tables that comprises second instructions, rules associated with the packet processing flow; and
performing, using a third one of the match-action tables that comprises third instructions, verification of the test based on the rules under the test and using the test packets.

19. The method of claim 18, further comprising:
receiving, in the first one of the match-action tables, a trigger comprising a template test packet from a host controller;
providing at least one first one of the test packets for the packet processing flow based in part on the trigger and the template test packet; and
providing at least one second one of the test packets based in part on a modification of the first one of the test packets.

20. The method of claim 18, further comprising:
receiving, in the first one of the match-action tables, a trigger comprising a template test packet from a host controller; and
generating, using the first one of the match-action tables, the test packets based in part on the trigger and the template test packet, wherein the generating comprises providing the template packet as a first one of the test packets and comprises modifying packet field properties, register values, destination ports, or destination match-action tables of the template test packet to provide a second one of the test packets.
